(19) United States
(12) Patent Application Publication
(10) Pub. No.: US 2008/0272063 A1
(43) Pub. Date: Nov. 6, 2008

(54) Ex Situ and in Situ Remediation with Activated Persulfate

(75) Inventors: Noel Boulos, Bellaire, TX (US); Doug Carvel, Woodlands, TX (US); Jason Muessig, Houston, TX (US)

Correspondence Address: OBLON, SPIVAK, MCCLELLAND MAIER & NEUSTADT, P.C., 1940 DUKE STREET, ALEXANDRIA, VA, 22314, US

(73) Assignee: Solvay, Brussels (BE)

(21) Appl. No.: 11/915,949

(22) PCT Filed: May 19, 2006
(86) PCT No.: PCT/EP2006/062473

§ 371 Date: Jun. 25, 2008

Related U.S. Application Data
(60) Provisional application No. 60/685,416, filed on May 31, 2005.

(51) Int. Cl. C02F 1/72; A62D 3/38

(52) U.S. Cl. 210/759; 588/320; 210/758

(57) ABSTRACT

The present invention relates to the in situ and ex situ oxidation of organic compounds in soils, sludges, ground-water, process water and wastewater and especially relates to the in situ oxidation of volatile and semi-volatile organic compounds, pesticides and herbicides, and other recalcitrant organic compounds, in soil and groundwater using percarbonate activated persulfate.

The present application claims the benefit of U.S. provisional application Ser. No. 60/685,416 filed May 31, 2005, herein incorporated by reference.

### FIELD OF THE INVENTION

The present invention relates to the in situ and ex situ oxidation of organic compounds present in soils, groundwater, process water and wastewater, and especially relates to the in situ oxidation of volatile, semi-volatile and non-volatile organic compounds, pesticides and herbicides, and other recalcitrant organic compounds in soils, groundwater, etc. using activated persulfate.

Additional advantages and other features of the present invention will be set forth in part in the description that follows and in part will become apparent to those having ordinary skill in the art upon examination of the following or may be leaned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### BACKGROUND OF THE INVENTION

Current oxidation technologies using activated persulfate are specifically associated with applications for the treatment of organic contaminants in soils and groundwater and are limited to activation technologies using iron, UV, heat, carbonate, and liquid (hydrogen) peroxide. See, e.g., WO 2005/012181 and WO 2004/002923, both incorporated herein by reference. These technologies are effective for the full range of organics within the saturated zone; however, each activation process targets a specific organic range of contaminants. The liquid peroxide activation process is very effective for a wider range of contaminants in the saturated zone but is limited in its effectiveness in shallow soils or sediments due to the nature of the liquid peroxide reactivity.

### SUMMARY OF THE INVENTION

The use of solid percarbonates and/or metal peroxides, especially of sodium percarbonate (PCS) calcium percarbonate, calcium peroxide, magnesium peroxide, or mixed calcium/magnesium peroxide, as the activation chemical allows for application of the activation chemical concurrently or sequentially with the persulfate and provides for both the desired activation of the persulfate and the controlled reaction within the targeted treatment zone without migration. The contaminants that can be effectively treated with this technology include petrochemicals, chlorinated organics, pesticides, energetics, perchlorates, etc.

### DETAILED DESCRIPTION OF THE PREFERRED EMBODIMENTS OF THE INVENTION

The present invention relates in a preferred embodiment to a method for the treatment of contaminated soils, sediments, clays, rocks, sands and the like (hereinafter collectively referred to as “soils”) containing organic contaminants, including but not limited to volatile organic compounds, semi-volatile organic compounds, non-volatile organic compounds, pesticides and herbicides, as well as the treatment of contaminated groundwater (i.e., water found underground in cracks and spaces in soil, sand and rocks), process water (i.e., water resulting from various industrial processes) or wastewater (i.e., water containing domestic or industrial waste, often referred to as sewage) containing these compounds.

Contaminants susceptible to treatment by the compositions of the present invention notably include various man-made and naturally occurring volatile hydrocarbons including chlorinated hydrocarbons and non chlorinated hydrocarbons, aromatic or polyaromatic ring compounds, brominated compounds, propellants or explosives, and so forth. Examples of chlorinated hydrocarbons are volatile organic compounds such as chlorinated olefins including tetrachloroethylene, trichloroethylene, cis-1,2-dichloroethane and vinyl chloride, but also non-volatile organic compounds such as polychlorinated biphenyls (PCBs) or dichlorobenzene. Usual non chlorinated compounds include total petroleum hydrocarbons (TPHs) including benzene, toluene, xylene, methyl benzene and ethylbenzene, but also methyl tert-butyl ether (MTBE), tert-butyl alcohol (TBA) or polyaromatic hydrocarbons (PRHs) such as naphthalene. Further examples of contaminants susceptible to treatment by the composition of the present invention are brominated solvents, 1,4-dioxane, insecticides, etc. An example of explosive is nitroaniline trinitrotoluene.

In accordance with a preferred method of the present invention the contaminants are present in an environmental medium. As used herein “environmental medium” refers to an environment where contaminants are found including, without limitation, soils, groundwater, process water, waste water, and the like.

The process of the present invention may be carried out in situ or ex situ. In situ treatment is conducted in the physical environment where the contaminant(s) are found. Ex situ treatment involves removal of the contaminated medium from the location where it is found and treatment at a different location.

In accordance with one process of the present invention, organic compounds present in an environmental medium are oxidized by contacting the organic compound with a composition comprising (a) at least one persulfate and (b) at least one persulfate activator chosen from percarbonates and/or metal peroxides.

Percarbonates useful for the present invention are for example sodium percarbonate or calcium percarbonate. The percarbonate is preferably sodium percarbonate. Metal peroxides useful for the present invention are for example calcium peroxide, magnesium peroxide, mixed calcium/magnesium peroxide or mixtures thereof. The metal peroxide is preferably calcium peroxide.

In a preferred embodiment of the invention a composition comprising (a) at least one persulfate and (b) at least one percarbonate and/or one metal peroxide compound is introduced into a soil containing at least one organic compound in sufficient quantities and under conditions to oxidize substantially all or a desired portion of the target organic compounds.

In a preferred embodiment, on a stoichiometric basis, the preferred mole ratio of (a) persulfate ion to (b) percarbonate ion and/or metal peroxide is 1:1. Other ratios may be used, for example a mole ratio (total persulfate)/(total percarbonate and/or metal peroxide) from 0.001 to 1000, more preferably from 0.01 to 100, even more preferably from 0.1 to 10, all mole ratios, including all values and all subranges between these stated values.

If a metal peroxide, such as calcium, magnesium or mixed calcium/magnesium peroxide, is used as activation chemical of the persulfate, the generation of hydrogen peroxide can be accelerated by the addition of at least one acid (e.g., inorganic such as HCl or organic acid). In an alternate embodiment, the contaminated medium could be acidified at the time of, after, and/or prior to dispersing the metal peroxide. Preferred pHs of the contaminated material, if this alternate route is chosen, is less than 7, 6.5, 6, less than 6, 5.5, 5, less than 5, 4.5, 4, less than 4, 3.5, 3, less than 3, 2.5, 2, less than 2, 1.5, 1, etc. The amount of acid used is not limited and depends on the amount of metal peroxide present, the nature of the contaminated material, etc. Useful amounts include 1 g, 5 g, 10 g, 20 g, 30 g, 40 g, 50 g, 100 g, 200 g, 300 g, etc. per kilogram of contaminated material. Those of ordinary skill in this art can determine the amount of acid to use based on this disclosure.

This methodology may also be used ex situ to treat quantities of contaminated soil, etc. which have been removed from their original location.

According to another aspect of the present invention, under conditions where metal cations are present in the contaminated soil or water, the composition, containing (a) persulfate and (b) percarbonate and/or metal peroxide, may be introduced into the contaminated soil to remove the target compounds. If the metal cations are not naturally present in sufficient quantities, they may be added from an external source in the form of metal salts, metal chelates or elemental metals. Such metal cations include divalent transition metals such as Fe+2. An example of chelated metal ion is Fe+3 chelated with ethylenediaminetetraacetic acid (EDTA), where the chelant provides enhanced stability and solubility of the metal ion.

As per another aspect of the present invention, the composition containing (a) persulfate and (b) percarbonate and/or metal peroxide, may be introduced into the soil, followed by heating of the soil. The soil is in general heated to a temperature up to 150° C., preferably up to 99° C. Likewise, the persulfate and percarbonate composition may be introduced into soil that has already been preheated.

In one embodiment of the present invention, the oxidation of organic compounds at a contaminated site is accomplished by the injection of a combination of (a) persulfate and (b) percarbonate and/or metal peroxide into the soil.

In a preferred form of the invention, sodium persulfate (Na₂S₂O₈) is introduced into the soil.

While sodium persulfate is a preferred persulfate, other persulfate compounds can be used. These include monopersulfates and dipersulfates. Dipersulfates are preferred because they are inexpensive, soluble in water, are relatively stable until activated, and survive for long periods in the groundwater saturated soil under typical site conditions. Potassium persulfate and ammonium persulfate are examples of other persulfates which can be used. If a monopersulfate is used, it will preferably be selected from sodium or potassium monopersulfate. In a further embodiment, the composition comprises at least one dipersulfate and at least one monopersulfate.

In another embodiment of the invention, additional activators, such as metals and chelated metal complexes, may also be added either in combination, sequential fashion or multiple sequential steps either to the addition of percarbonate, metal peroxide, persulfate, or both (a) persulfate and (b) percarbonate and/or metal peroxide.

The composition of the invention can also comprise an additional activator, preferably chosen from a divalent or trivalent transition metals. Additional activators which may be used to enhance the effects of the persulfate/percarbonate and/or persulfate/metal peroxide include divalent and trivalent transition metals such as Fe (II), Fe (III), Cu (II), Mn (II) and Zn (II). The transition metal is preferably chosen from Fe (II) or Fe (III). The metal may be added in the form of a salt, chelate or elemental metal. Preferred chelants which may be used include ethylenediaminetetraacetic acid (EDTA), citric acid, phosphate, phosphonates, glucoheptonates, aminocarboxylates, polyacrylates, and nitrilotriacetic acid.

In addition to treatment of soils, the invention is also useful for destroying contaminants in groundwater, process water, waste water or any other environment in which contaminants susceptible to oxidation are found.

In a preferred form of the invention, the percarbonate and/or the metal peroxide is introduced in situ into the soil.

For in situ soil treatment, injection rates should preferably be chosen based upon the hydrogeologic conditions, that is, the ability of the oxidizing composition to displace, mix and disperse with existing groundwater and move through the soil.

The (a) persulfate and (b) percarbonate and/or metal peroxide may be provided as a dry blend prior to shipment to the site where the composition is to be used. However, it is also possible to combine the ingredients to prepare the composition at the site. Alternatively, the components may be injected sequentially at the site and the composition formed in situ.

The (a) persulfate and (b) percarbonate and/or metal peroxide may be mixed together and shipped or stored prior to being combined with water in the same vessel prior to injection.

Depending upon the type of soil, target compounds, and other oxidant demand by the site, the concentrations of (a) persulfate and (b) percarbonate and/or metal peroxide used in the present invention may vary from 0.5 g/kg to greater than 250 g/kg based on the medium to treat. The useful concentration of persulfate and percarbonate or metal peroxide may be determined without undue effort by one of ordinary skill in view of this disclosure. For guidance purposes only, one may use generally from 1%-8% persulfate and 0.5% to 10% percarbonate based on the medium to treat. The preferred concentrations are a function of the soil characteristics, including the site-specific oxidant demands.

Hydrogeologic conditions govern the rate of movement of the chemicals through the soil, and those conditions should be considered together with the soil chemistry to understand how best to perform the invention remediation. The techniques for making these determinations and performing the injections are well known in the art. For example, wells or borings can be drilled at various locations in and around the suspected contaminated site to determine, as closely as possible, where the contamination is located. Core samples can be withdrawn, being careful to protect the samples from atmospheric oxidation. The samples can then be used to determine soil oxidant demand and chemical (e.g. VOC) oxidant demand and the oxidant stability existing in the subsurface. The precise chemical compounds in the soil and their concentration can be determined. Contaminated groundwater can be collected. Oxidants can be added to the collected groundwater during laboratory treatability experiments to determine which compounds are destroyed, in what order and to what degree, in the groundwater. It can then be determined whether the same oxidants are able to destroy those chemicals in the soil environment.

In addition to in situ applications the process may also be employed ex situ. In addition to soils, it may be used to treat sludges, tars, groundwater, wastewater, process water or industrial water.

Another exemplary form of the invention is useful for destroying relatively low level, but unacceptable, concentrations of organic compounds in groundwater.

In a preferred embodiment, one provides a target in situ concentration of, for example, 1-2% persulfate activated by an in situ concentration of 0.5-3% percarbonate and/or metal peroxide based on the medium to treat.

The percarbonate and/or metal peroxide can be mixed with the appropriate ratio of persulfate and then mixed into dry soil in situ. After the chemicals are mixed into the soil through the depth of targeted organic contamination, the treatment area can be irrigated at a rate to achieve and maintain a near saturated condition preferably without over-saturation. The site can be maintained at a near saturated condition throughout the treatment period which can be, for example, up to 6 weeks or more. Supplemental augmentation with additional chemicals is possible throughout the treatment period. Alternatively, water can already be present, for example, in a pit, and the chemicals are added together with fill soil.

The invention persulfate/percarbonate and/or persulfate/metal peroxide composition can be applied either as an injected suspension, a dry mixture, in a sequential dry or liquid batch application. The sequencing can be either (a) persulfate applied prior to (b) percarbonate and/or metal peroxide, or in the reverse sequence, etc. This method can also be applied in two steps, with (a) persulfate and (b) percarbonate and/or metal peroxide added first and allowed to react. At a later time, either more percarbonate or metal peroxide or (a) persulfate and (b) percarbonate and/or metal peroxide is added, whereby the ratio of percarbonate and/or metal peroxide to persulfate is higher in the second step.

The (a) persulfate and (b) percarbonate and/or metal peroxide can thus be applied simultaneously or sequentially to the soil, groundwater, process water, or wastewater comprising at least one of a volatile organic compound, a semi-volatile organic compound, a non-volatile organic compound, a pesticide or an herbicide. The persulfate can be applied to the medium comprising the organic compound prior to the application of percarbonate and/or metal peroxide, or the percarbonate and/or metal peroxide can be applied prior to the application of the persulfate. The (a) persulfate and (b) percarbonate and/or metal peroxide can be applied sequentially in repeated applications. The repeated sequential additions can occur continuously or can be separated by time intervals.

The above written description of the invention provides a manner and process of making and using it such that any person skilled in this art is enabled to make and use the same, this enablement being provided in particular for the subject matter of the appended claims, which make up a part of the original description.

As used above, the phrases “selected from the group consisting of,” “chosen from,” and the like include mixtures of the specified materials.

The invention persulfate/percarbonate and/or persulfate/metal peroxide composition contains, in all embodiments, (a) at least one persulfate and (b) at least one percarbonate and/or one metal peroxide.

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

The examples which follow are intended to illustrate the invention without restricting it in its scope.

### EXAMPLES

### Example 1

A set of laboratory experiments was undertaken to simulate the efficacy of sodium persulfate/sodium percarbonate combination for the treatment of groundwater contamination. The contaminant chosen was methyl tert-butyl ether (MTBE).

Five sets of experiments were carried out with sodium persulfate and various amounts of sodium percarbonate, with a fixed volume of ferrous sulfate added to the solution. The starting MTBE concentration of each experiment was 5 ppm.

Seven sealable BOD (Biological Oxygen Demand) vials were filled with 200 mL of a 5 ppm solution of MTBE, and quickly sealed.

One of the vials was immediately transferred to a VOA vial (Volatile Organic Analysis), and set aside as a positive control (Spike). A second control contained 4 grams of iron (ferrous sulfate) added to the 200 mL of 5 ppm MTBE solution, was kept as a negative control (GW control).

The chemical reactants were sodium percarbonate and sodium persulfate. Both were added to the remaining five vials. The amount of sodium persulfate was kept the same (4 g), and only the amount of sodium percarbonate was changed (from 1 to 16 g). The following amounts of chemicals were added to each vial.

| | |
|---|---|
| GW R-1 | 4 g ferrous sulfate, 4 g sodium persulfate, 1 g sodium |
| | percarbonate |
| GW R-2 | 4 g ferrous sulfate, 4 g sodium persulfate, 2 g sodium |
| | percarbonate |
| GW R-3 | 4 g ferrous sulfate, 4 g sodium persulfate, 4 g sodium |
| | percarbonate |
| GW R-4 | 4 g ferrous sulfate, 4 g sodium persulfate, 8 g sodium |
| | percarbonate |
| GW R-5 | 4 g ferrous sulfate, 4 g sodium persulfate, 16 g sodium |
| | percarbonate |

As soon as each chemical was added to the vials, the pH and dissolved oxygen (D.O) levels were measured, and the vials were sealed and allowed to react.

The initial dissolved oxygen (D.O.) level was greater than saturation (approximately 20 ppm) for all vials. The reactions were allowed to progress for approximately three days, until the D.O. levels were less than 20 ppm. At that time, the solutions were transferred to VOA vials for analysis of MTBE and its degradation product tert-butyl alcohol (TBA). These results are summarized in the table below.

| | | MTBE | TBA | Total |
|---|---|---|---|---|
| Samples | pH | (μg/L) | (μg/L) | (μg/L) |
| Spike | n/a | 4900 | ND | 4900 |
| GW Control | n/a | 3500 | 640 | 4140 |
| GW R-1 | 2.72 | 570 | 1400 | 1870 |
| GW R-2 | 3.6 | 920 | 1800 | 2720 |
| GW R-3 | 8.26 | 2400 | 580 | 2980 |
| GW R-4 | 10.1 | 2800 | 0 | 2800 |
| GW R-5 | 10.53 | 1700 | 0 | 1700 |

Based upon these results, it can be concluded that the combination of persulfate and sodium percarbonate is effective at degrading MTBE and its degradation product TBA at all pHs tested.
At the lowest pH of 2.5, MTBE was oxidized the most, with some degradation of TBA.
At higher pHs, MTBE is oxidized at a lower rate, but the reaction progresses past TBA and most likely all the way to CO₂.
The lowest amount of total contaminants was obtained at the highest pH of ˜10.5.

### Example 2

Shallow soil and groundwater at a former fuel pipeline pumping station were contaminated with petroleum hydrocarbon (TPH) from former pipeline operations.

The contamination was over an area of approximately 600 sf (55.7 m²), with a thickness of 4 feet (1.2 m), beginning at a depth of 5 feet (1.5 m) below the ground surface (ft bgs) at the water table. Highly impacted soils above the water table had been excavated and disposed of off site.

The soil was comprised of uniform silty sand with a permeability of approximately 10⁻³ cM/sec². The contamination was uniformly distributed throughout the impacted soil column within the treatment area.

The initial concentration of dissolved petroleum hydrocarbon in the treatment area was approximately 200 parts per million (ppm). Soil concentrations were, on average, approximately 20 times the dissolved phase concentration.

A combination of sodium percarbonate and sodium persulfate was chosen to treat this site. The treatment was performed by sequentially applying the chemical components in the excavation.

The initial application consisted of adding and mixing 2,250 lbs (1020.6 kg) of sodium persulfate and 500 lbs (226.8 kg) of ferrous sulfate in the water contained within the excavation. Then 1,000 lbs (453.6 kg) of sodium percarbonate were uniformly mixed within clean fill soil.

The fill soil was then placed in the excavation in 6 inch (15.2 cm) loose lifts allowing for saturation to occur. During backfill operations, a single piezometer was placed in the center of the treatment area to monitor the reaction progress via dissolved oxygen levels.

The initial Dissolved Oxygen (D.O.) was found to be above saturation level (approximately 20 ppm). The site was allowed to react until the products of reaction were stabilized, and Dissolved Oxygen (D.O.) was found to be below 20 ppm. This period was 6 weeks.

After the dissolved oxygen levels dropped to measurable levels, a groundwater sample was taken and analyzed for TPH. The analyses demonstrated a reduction of dissolved concentrations of petroleum hydrocarbons to levels below the target of 10 ppm. This represented an average reduction in TPH mass in excess of 95%.

1. A method for oxidizing an organic compound comprising contacting the organic compound with a composition comprising (a) at least one persulfate and (b) at least one percarbonate and/or at least one metal peroxide.

2. The method of claim 1, wherein the organic compound is present in soil, groundwater, process water or wastewater.

3. The method of claim 1, wherein the organic compound is present in an environmental medium and composition is introduced into the environmental medium in situ.

4. The method of claim 1, wherein the organic compound is present in an environmental medium the composition is introduced into the environmental medium ex situ.

5. The method of claim 1, wherein the organic compound is selected from the group consisting of volatile organic compounds, semi-volatile organic compounds, non-volatile organic compounds, pesticides and herbicides.

6. The method of claim 1, wherein the persulfate is a dipersulfate.

7. The method of claim 6, wherein the dipersulfate is sodium, potassium or ammonium persulfate or a combination thereof.

8. The method of claim 1, wherein the persulfate compound is a monopersulfate.

9. The method of claim 8, wherein the monopersulfate is selected from sodium and potassium monopersulfate or a combination thereof.

10. The method of claim 1, wherein the composition comprises at least one dipersulfate and at least one monopersulfate.

11. The method of claim 1, wherein the percarbonate is sodium percarbonate.

12. The method of claim 1, wherein the metal peroxide is chosen from calcium peroxide, magnesium peroxide, mixed calcium/magnesium peroxide, or mixtures thereof.

13. The method of claim 1 wherein (a) persulfate and (b) percarbonate and/or metal peroxide are present in combination so that the mole ratio (total persulfate)/(total percarbonate and/or metal peroxide) is from 0.01 to 100.

14. The method of claim 13 wherein (a) persulfate and (b) percarbonate and/or metal peroxide are present in combination so that the ratio (total persulfate)/(total percarbonate and/or metal peroxide) is from 0.1 to 10.

15. The method of claim 1 wherein the persulfate is selected from the group consisting of sodium persulfate, potassium persulfate, ammonium persulfate, sodium monopersulfate, potassium monopersulfate, and mixtures thereof.

16. The method of claim 1, wherein the composition is introduced into soil containing comprising at least one organic compound in sufficient quantities and under conditions to oxidize substantially all or a desired portion of the target organic compound.

17. The method of claim 16, wherein the composition is introduced into the soil either in situ or ex situ.

18. The method of claim 17, wherein the soil is heated to a temperature up to 150° C.

19. The method of claim 1, wherein the composition further comprises an additional activator.

20. The method of claim 19, wherein the additional activator is a divalent or trivalent transition metal.

21. The method of claim 20, wherein the additional activator is a divalent transition metal selected from the group consisting of Fe (II), Cu (II), Mn (II), and Zn (II), or a trivalent transition metal.

22. The method of claim 20, wherein the additional activator is a divalent or trivalent transition metal combined with a chelating agent.

23. The method of claim 22, wherein the chelating agent is ethylenediaminetetraacetic acid, citric acid, phosphate, phosphonate, or nitrilotriacetic acid.

24. The method of claim 1, wherein (a) persulfate and (b) percarbonate and/or metal peroxide are applied simultaneously to soil, groundwater, process water, or wastewater comprising at least one of a volatile organic compound, a semi-volatile organic compound, a non-volatile organic compound, a pesticide or an herbicide.

25. The method of claim 1, wherein (a) persulfate and (b) percarbonate and/or metal peroxide are applied sequentially to soil, groundwater, process water, or wastewater comprising at least one of a volatile organic compound, a semi-volatile organic compound, a non-volatile organic compound, a pesticide or an herbicide.

26. The method of claim 25, wherein the persulfate is applied to a medium comprising the organic compound prior to the application of the percarbonate and/or metal peroxide.

27. The method of claim 25, wherein the percarbonate and/or metal peroxide is applied to a medium comprising the organic compound prior to the application of the persulfate.

28. The method of claim 25, wherein the persulfate and percarbonate and/or metal peroxide are applied to a medium comprising the organic compound sequentially in repeated applications.

29. The method of claim 28, wherein the repeated sequential additions of (a) persulfate and (b) percarbonate and/or metal peroxide occur continuously.

30. The method of claim 28, wherein the repeated sequential additions of (a) persulfate and (b) percarbonate and/or metal peroxide are separated by time intervals.

31. The method of claim 1, wherein organic compound is present in an environmental medium selected from the group consisting of soils, sludges, groundwater, wastewater, and process water.
